(19) United States
(12) Patent Application Publication
(10) Pub. No.: US 2016/0122556 A1
(43) Pub. Date: May 5, 2016

(54) Spray Layer Capable Of Germ-Eradication, Finger Print Prevention, And Good Touch Feeling, Its Application, And Method Of Spraying The Same

(71) Applicant: NINGBO RUNNER INDUSTRIAL CORPORATION, Zhejiang (CN)

(72) Inventors: Zhou-Ji Yang, Zhejiang (CN); Ying-Quan Wang, Zhejiang (CN)

(21) Appl. No.: 14/852,099

(22) Filed: Sep. 11, 2015

(30) Foreign Application Priority Data
Oct. 31, 2014 (CN) 201410606704.3

(51) Int. Cl. C09D 5/14; B05D 3/02; B05D 7/14; C09D 175/04; C09D 7/12

(52) U.S. Cl. CPC C09D 5/14; C09D 175/04; C09D 7/1233; C09D 7/1216; B05D 7/14; B05D 3/0272; C08K 5/54

(57) ABSTRACT

Disclosed is a spray layer capable of germ eradication, finger prints prevention, and good touch feeling, comprising ingredients of following weight percentage (wt %): polyurethanes resin 20 wt %˜40 wt %, isocyanate curing agent 3 wt %˜10 wt %, touch feeling agent 6 wt %˜15 wt %, dissipation agent 1 wt %˜2 wt %, drier activation agent 0.1 wt %˜1 wt %, leveling agent 0.5 wt %˜2 wt %, diluting agent 10 wt %˜40 wt %, graffiti barrier agent 5 wt %˜15 wt %, germicide A 0.5 wt %˜1.5 wt %,germicide B 0.2 wt %˜1 wt %. Also disclosed are a method of spraying the spray layer, and an application of the spray layer.

### BACKGROUND OF THE INVENTION

1. Field of the Invention

The present invention relates to a spray layer, and in particular to a polyurethanes spray layer capable of germ eradication, finger prints prevention, and good touch feeling, its application, and a method of spraying the same.

2. The Prior Arts

Along with the raise of living standard, more and more emphases are put on the human factors of product design. To the conventional hand rail of stainless steel, the portion in contact with the hand is the polished surface of stainless steel, it could give a cold and frigid feeling in winter when touched with a hand, thus making people feel uncomfortable. Also, the polished surface is slippery, such that when people trip or fall while walking, it won't be any help by holding onto such a hand rail. In addition, since quite a lot of people may touch the hand rail everyday, various germs may be left on the hand rail, such that the germs may be spread and distributed to cause contagion through touching the hand rail, to cause dissemination of diseases, thus constituting a threat to the health of people.

In order to overcome the shortcomings mentioned above, it is important and imperative to develop a spray layer utilized on a hand rail having the capabilities of germ eradication, finger prints prevention, and good touch feeling. In China Patent No. CN 202169745U is disclosed a germ eradicating color spray steel plate, which includes a plate material layer, and a spray layer on each of two sides of the plate material layer. On the surface of the spray layer is disposed a germ eradication layer, while the germ eradication layer is an Ag layer of nm scale. Further, in China Patent No. CN103881489A is disclosed an environment protection type steering wheel surface spray layer, composed of materials of the following weight percentage (wt %): elastic material 15%, Polyvinyl alcohol resin 25 wt %, rubber powder 6˜10 wt %, flame retardant 15 wt %, film forming additive 5˜9 wt %, ceramic powder 2 wt %, and spice 1 wt %. The environment protection type steering wheel surface spray layer thus produced has the advantages of high mechanical strength, no stimulating odor, good touch feeling, and not liable to slip. In addition, in China Patent No. CN201287492 is disclosed a stainless steel having spray layer, composed of a stainless steel plate, and a transparent spray layer attached onto the stainless steel plate. The transparent spray layer is of nm scale, and is composed of: acrylic resin 95 wt %, zinc phosphate 2wt %, silicon dioxide of nanometer scale 3 wt %. However, despite their respective merits, for the existing technologies mentioned above, they are not capable of germ eradication, finger prints prevention, and having good touch feeling at the same time.

Therefore, presently, the design and performance of the spray layer on the surface of stainless steel is not quite satisfactory, and it leaves much room for improvement.

### SUMMARY OF THE INVENTION

In view of the problems and drawbacks of the prior art, the present invention provides a spray layer capable of germ eradication, finger prints prevention, and good touch feeling, its application, and a method of spraying the same, to overcome the shortcomings of the prior art.

A major objective of the present invention is to provide a spray layer capable of germ eradication, finger prints prevention, and good touch feeling, its application, and a method of spraying the same

According to a first aspect of the present invention, the present invention provides a spray layer capable of germ eradication, finger prints prevention, and good touch feeling, including the following ingredients having the respective weight percentages (wt %):

| | |
|---|---|
| polyurethanes resin | 20%~40% |
| isocyanate curing agent | 3%~10% |
| touch feeling filler | 6%~15% |
| dispersing agent | 1%~2% |
| drier activator | 0.1%~1% |
| leveling agent | 0.5%~2% |
| diluting agent | 10%~40% |
| graffiti barrier agent | 5%~15% |
| germicide | 0.2%~2.5% |

Preferably, the touch feeling filler is organic silicon and/or organic silicon modified substance, with its molecule weight of 4000˜6000.

Preferably, the drier activator is composed of one or more of the following group consisting of: Co, Mn, Cr, Pb, Zn, Fe, Ca, and rare earth elements.

Preferably, the graffiti barrier agent is Polydimethylsiloxane (PDMS) emulsion, having hydroxyl contents of 0.5 wt %˜10 wt %.

Preferably, germicide is composed of one or more of the following group consisting of: 5-chlorine-2-methyl-4-isothiazolin-3-ketone, 2-methyl-4-isothiazolin-3-ketone, 1,2-benzisothiazolin-3-ketone, 2-octyl-4-isothiazolin-3-ketone, 2-methyl-4,5-propylidene-4-isothiazolin-3-ketone,4,5-dichlorine-2-octyl-4-isothiazolin-3-ketone. Preferably, the germicide is composed of two kinds of ingredients of germicide mentioned above. The weight percentages of the these two kinds of ingredients are respectively 0.5 wt %˜1.5 wt %, and 0.2 wt %˜1 wt %.

According to a second aspect of the present invention, the present invention provides a spray method for the spray layer mentioned above, including the following steps: firstly, mixing evenly the ingredients of the spray layer mentioned above, and then pouring it into a spraying gun to perform spraying. Secondly, placing the spray layer thus formed into an oven to bake at 70° C.˜100° C., preferably 80° C.˜100, for example 90° C., for at least 30 minutes, for example 30˜90 minutes.

Preferably, the thickness of the spray layer is 30 μm to 60 μm, more preferably 30 μm to 40 μm.

According to a third aspect of the present invention, the present invention provides an application of the spray layer mentioned above as a surface paint, to spray the spray layer on a coating surface as a surface paint.

Preferably, the coating surface is composed of one or more of the following group consisting of: stainless steel, plastic, metal, wood, leather, textile, and cement. More preferably, the coating surface is composed of stainless steel.

Preferably, between the coating surface and the surface paint is provided with primer paint and/or color paint.

Compared with the prior art, the present invention has the following advantages:

The present invention provides a spray layer capable of germ eradication, finger prints prevention, and good touch feeling, and it is mainly utilized in making stainless steel hand rail, and having the following functions:

1. Its good touch feeling function is capable of removing the cold and frigid feeling of touching the hand rail surface in winter, meanwhile it is slip proof;

2. Its germ eradication function is capable of eradicating the germs on the surface of the hand rail, to eliminate hazard to health ; and

3. Its finger prints prevention function is capable of keeping the surface of the hand rail clean, and not liable to be stained.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

(No Drawings)

### DETAILED DESCRIPTION OF THE PREFERRED EMBODIMENT

The purpose, construction, features, functions and advantages of the present invention can be appreciated and understood more thoroughly through the following detailed description with reference to the attached drawings.

### Embodiment 1

The present embodiment provides a spray layer capable of germ eradication, finger prints prevention, and good touch feeling, and a method of spray such a spray layer, comprising the following steps:

1.Cleaning the Stainless Steel Hand Rail, Including De-Waxing, De-Greasing, and Baking to Dry.

2. Spraying the Primer Paint.

(a) Preparing the Primer Paint:
The weight percentages (wt %) of the various ingredients are as follows:

| | |
|---|---|
| polyurethanes resin | 20 wt %~60 wt % |
| isocyanate curing agent | 5 wt %~15 wt % |
| leveling agent | 0.5 wt %~2 wt % |
| diluting agent | 20 wt %~50 wt % |

mixing the ingredients listed above evenly, and turning and churning the mixture at 200 rpm for 30 minutes.

(b) Spraying the Primer Paint
Washing the spraying gun clean with water, then pouring 150 ml the prepared primer paint into the spraying gun, to perform spraying the spray layer to a thickness of about 15 μm˜20 μm.

(c) Putting it Aside to Dry Up, and Preparing to Spray the Surface Paint;

3. Spraying the Surface Paint

(a) Preparing the Surface Paint
The weight percentages (wt %) of the various ingredients are as follows:

| | |
|---|---|
| polyurethanes resin | 20 wt %~40 wt % |
| isocyanate curing agent | 3 wt %~10 wt % |
| touch feeling agent | 6 wt %~15 wt % |
| dissipation agent | 1 wt %~2 wt % |
| drier activation agent | 0.1 wt %~1 wt % |
| leveling agent | 0.5 wt %~2 wt % |
| diluting agent | 10 wt %~40 wt % |
| graffiti barrier agent | 5 wt %~15 wt % |
| germicide A | 0.5 wt %~1.5 wt % |
| germicide B | 0.2 wt %~1 wt % |

In the descriptions above, the touch-feeling filler is an organic silicon and/or organic silicon modified substance, with its molecule weight of 4000˜6000. The drier activator is composed of one or more of the following group consisting of: Co, Mn, Cr, Pb, Zn, Fe, Ca, and rare earth elements. The graffiti barrier agent is Polydimethylsiloxane (PDMS) emulsion, having hydroxyl contents of 0.5 wt % to 10 wt %. The germicides A and B are each composed of one or more of the following group consisting of: 5-chlorine-2-methyl-4-isothiazolin-3-ketone, 2-methyl-4-isothiazolin-3-ketone, 1,2-benzisothiazolin-3-ketone, 2-octyl-4-isothiazolin-3-ketone, 2-methyl-4,5-propylidene-4-isothiazolin-3-ketone, 4,5-dichlorine-2-octyl-4-isothiazolin-3 -ketone.

Mixing the ingredients listed above evenly, and turning and churning the mixture at 200 rpm for 30 minutes.

(b) Spraying the Surface Paint

Washing the spraying gun clean with water, then pouring 150 ml the prepared surface paint into the spraying gun, to perform spraying the spray layer to a thickness of about 30 μm˜60 μm, preferably 30 μm˜40 μm.

(c) Placing the spray layer thus formed into an oven to bake at 70° C.˜100° C., preferably 80 μm˜100° C., for example 90° C., for at least 30 minutes, for example 30˜90 minutes.

The finished spray layer thus formed could give a soft feeling when touched by hand. When it is in contact with water, ball-shape water drops can be seen falling from the spray layer.

4. Function Tests:

For the results of functional tests, refer to Table 1 below:

TABLE 1

| test item | test standard | test results | verification |
|---|---|---|---|
| hot and cold | test standard (1) | no noticeable change | OK |
| cycle test | | on surface of | |
| | | product, and no | |
| | | peeling-off of | |
| | | surface coating layer | |
| | | of product | |
| salt mist test | ASTM B117-11 (2) | no noticeable change | OK |
| | | on surface of | |
| | | product, | |
| water | ASTM D-870 (3) | no color change on | OK |
| immersion | | surface of product, | |
| test | | no bubble, no | |
| | | whiting. | |
| adhesion test | ASTM D-3359-02 | no peeling-off of | OK |
| | (4) | surface coating layer | |
| | | of product (5B) | |
| film | Principle of electro- | 45 μm~55 μm | OK |
| thickness | magnetic test of | | |
| test | thickness | | |
| germ | JIS Z 2801 | germ eradication rate | OK |
| eradication | standard | for escherichia coli | |
| test | | ≧99.99%, and | |
| | | for Staphylococcus | |
| | | aureus ≧99.99% | |

In the Table 1 mentioned above, note (1) indicates that, the product having the spray layer is put in the two extreme temperatures of −18° C. and 49° C. for 12 hours respectively, then observe with naked eyes if the surface of the product has any damages or noticeable changes, and subsequently, it has to pass the adhesion test.

Note (2) indicates that, the test is performed according to test standard ASTM B117-11, such that after the product is put in a 5% neutral salt mist environment for 24 hours, no corrosion occurs to the surface of the spray layer.

Note (3) indicates that, after the product is immersed in pure water at 60° C. for 24 hours, fetch out the product to let it cool down to room temperature, then observe if whiting or bubbles occurs to the surface of the spray layer, large amount changes or regional changes are not allowed.

Note (4) indicates that, the surface adhesion for the spray layer of the product can reach above grade 4B.

### Embodiment 2

The present embodiment provides a black or yellow spray layer capable of germ eradication, finger prints prevention, and good touch feeling, and a method of spray such a spray layer, comprising the following steps:

1. Cleaning the Stainless Steel Hand Rail, Including De-Waxing, De-Greasing, and Baking to Dry.

2. Spraying the Primer Paint.

(a) Preparing the Primer Paint:
the weight percentages (wt %) of the various ingredients are as follows:

| | |
|---|---|
| epoxy | 20 wt %~40 wt % |
| curing agent | 10 wt %~20 wt % |
| leveling agent | 0.5 wt %~2 wt % |
| diluting agent | 40 wt %~60 wt % |

Mixing the ingredients listed above evenly, and turning and churning the mixture at 200 rpm for 30 minutes.

(b) Spraying the Primer Paint

Washing the spraying gun clean with water, then pouring 150 ml the prepared primer paint into the spraying gun, to perform spraying the spray layer to a thickness of about 10 μm˜20 μm.

(c) Putting it aside to dry up, and preparing the spraying of middle paint (color paint);

3. Spraying the Middle Paint (Color Paint)

(a) Preparing the Middle Paint (Color Paint)
the weight percentages (wt %) of the various ingredients are as follows:

| | |
|---|---|
| polyurethanes resin | 20 wt %~40 wt % |
| color paste (black or yellow color paste) | 5 wt %~10 wt % |
| leveling agent | 0.5 wt %~2 wt % |
| diluting agent | 40 wt %~60 wt % |

Mixing the ingredients listed above evenly, and turning and churning the mixture at 200 rpm for 30 minutes.

(b) Spraying the Middle Paint (Color Paint)

Washing the spraying gun clean with water, then pouring 150 ml the prepared middle paint (color paint) into the spraying gun, to perform spraying the spray layer to a thickness of about 15 μm˜20 μm.

(c) Putting it Aside to Dry Up, and Preparing the Spray of Surface Paint;

4. Spraying Surface Paint;

(a) Preparing the Surface Paint:
The weight percentages (wt %) of the various ingredients are as follows:

| | |
|---|---|
| polyurethanes resin | 20 wt %~40 wt % |
| isocyanate curing agent | 3 wt %~10 wt % |
| touch feeling agent | 6 wt %~15 wt % |
| dissipation agent | 1 wt %~2 wt % |
| drier activation agent | 0.1 wt %~1 wt % |
| leveling agent | 0.5 wt %~2 wt % |
| diluting agent | 10 wt %~40 wt % |
| graffiti barrier agent | 5 wt %~15 wt % |
| germicide A | 0.5 wt %~1.5 wt % |
| germicide B | 0.2 wt %~1 wt % |

In the descriptions above, the touch feeling filler is an organic silicon and/or organic silicon modified substance, with its molecule weight of . The drier activator is composed of one or more of the following group consisting of: Co, Mn, Cr, Pb, Zn, Fe, Ca, and rare earth elements. The graffiti barrier agent is Polydimethylsiloxane (PDMS) emulsion, having hydroxyl contents of 0.5 wt %˜10 wt %. The germicides A and B are each composed of one or more of the following group consisting of: 5-chlorine-2-methyl-4-isothiazolin-3-ketone, 2-methyl-4-isothiazolin-3-ketone, 1,2-benzisothiazolin-3-ketone, 2-octyl-4-isothiazolin-3-ketone, 2-methyl-4,5-propylidene-4-isothiazolin-3-ketone, 4,5-dichlorine-2-octyl-4-isothiazolin-3 -ketone.

Mixing the ingredients listed above evenly, and turning and churning the mixture at 200 rpm for 30 minutes.

(b) Spraying the Surface Paint
Washing the spraying gun clean with water, then pouring 150 ml the prepared surface paint into the spraying gun, to perform spraying the spray layer to a thickness of about 30 μm˜60 μm, preferably 30 μm˜40 μm.

(c) Placing the spray layer thus formed into an oven to bake at 70° C.˜100° C., preferably 80° C.˜100° C., for example 90° C., for at least 30 minutes, for example 30˜90 minutes.

The finished spray layer thus formed could give a soft feeling when touched by hand. When it is in contact with water, ball-shape water drops can be seen falling from the spray layer.

4. Function Tests:

For the results of functional tests, refer to Table 2 below:

TABLE 2

| test item | test standard | test results | verification |
|---|---|---|---|
| hot and cold | test standard (1) | no noticeable change | OK |
| cycle test | | on surface of | |
| | | product, and no | |
| | | peeling-off of | |
| | | surface coating layer | |
| | | of product | |
| salt mist test | ASTM B117-11 (2) | no noticeable change | OK |
| | | on surface of | |
| | | product, | |
| water | ASTM D-870 (3) | no color change on | OK |
| immersion | | surface of product, | |
| test | | no bubble, no | |
| | | whiting. | |
| adhesion test | ASTMD-3359-02 | no peeling-off of | OK |
| | (4) | surface coating layer | |
| | | of product (5B) | |
| film | principle of electro- | 60 μm~70 μm | OK |
| thickness | magnetic test of | | |
| test | thickness | | |
| germ | JIS Z 2801 | germ eradication rate | OK |
| eradication | standard | for escherichia coli | |
| test | | ≧99.99%, and | |
| | | for Staphylococcus | |
| | | aureus ≧99.99% | |

In the Table 2 mentioned above, note (1) indicates that, the product having the spray layer is put in the two extreme temperature of −18° C. and 49° C. for 12 hours respectively, then observe with naked eyes if the surface of the product has any damages or noticeable changes, and subsequently, it has to pass the adhesion test.

Note (2) indicates that, the test is performed according to test standard ASTM B117-11, such that after the product is put in a 5% neutral salt mist environment for 24 hours, no corrosion occurs to the surface of the spray layer.

Note (3) indicates that, after the product is immersed in pure water at 60° C. for 24 hours, fetching out the product to let it cool down to room temperature, then observe if whiting or bubbles occur to the surface of the spray layer, large amount changes or regional changes are not allowed.

Note (4) indicates that, the surface adhesion for the spray layer of the product can reach above grade 4B.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A spray layer capable of germ eradication, finger prints prevention, and good touch feeling, comprising ingredients of following weight percentage (wt %):

| | |
|---|---|
| polyurethanes resin | 20 wt %~40 wt % |
| isocyanate curing agent | 3 wt %~10 wt % |
| touch feeling agent | 6 wt %~15 wt % |
| dissipation agent | 1 wt %~2 wt % |
| drier activation agent | 0.1 wt %~1 wt % |
| leveling agent | 0.5 wt %~2 wt % |
| diluting agent | 10 wt %~40 wt % |
| graffiti barrier agent | 5 wt %~15 wt % |
| germicide | 0.2 wt %~2.5 wt %. |

2. The spray layer capable of germ eradication, finger prints prevention, and good touch feeling as claimed in claim 1, wherein the touch feeling filler is organic silicon and/or organic silicon modified substance, with its molecule weight of 4000˜6000.

3. The spray layer capable of germ eradication, finger prints prevention, and good touch feeling as claimed in claim 1, wherein the drier activator is composed of one or more of following group consisting of: Co, Mn, Cr, Pb, Zn, Fe, Ca, and rare earth elements.

4. The spray layer capable of germ eradication, finger prints prevention, and good touch feeling as claimed in claim 1, wherein the graffiti barrier agent is Polydimethylsiloxane (PDMS) emulsion, having hydroxyl contents of 0.5 wt %˜10 wt %.

5. The spray layer capable of germ eradication, finger prints prevention, and good touch feeling as claimed in claim 1, wherein the germicide is composed of one or more of following group consisting of: 5-chlorine-2-methyl-4-isothiazolin-3-ketone, 2-methyl-4-isothiazolin-3-ketone, 1,2-benzisothiazolin-3-ketone, 2-octyl-4-isothiazolin-3-ketone, 2-methyl-4,5-propylidene-4-isothiazolin-3-ketone, and 4,5-dichlorine-2-octyl-4-isothiazolin-3-ketone.

6. A method of spraying the spray layer as claimed in claim 1, comprising following steps:
mixing evenly the ingredients as claimed in claim 1, then pouring it into a spraying fun to perform spraying; and putting the spray layer thus obtained into an oven at a temperature of 70° C. ˜100° C., to bake at least 30 minutes.

7. The method of spraying the spray layer as claimed in claim 1 as claimed in claim 6, wherein thickness of the spray layer is 30 μm˜60 μm.

8. An application of the spray layer as claimed in claim 1 as a surface paint, comprising:
spraying on a coating surface the spray layer as claimed in claim 1 as the surface paint.

9. The application of the spray layer as claimed in claim 1 as a surface paint as claimed in claim 8, wherein the coating surface is composed of one or more of the following group consisting of: stainless steel, plastic, metal, wood, leather, textile, and cement.

10. The application of the spray layer as claimed in claim 1 as a surface paint as claimed in claim 8, wherein between the coating surface and the surface paint is disposed a primer paint and/or a color paint.
